(19) United States
(12) Patent Application Publication
(10) Pub. No.: US 2013/0144646 A1
(43) Pub. Date: Jun. 6, 2013

(54) Systems and Methods for Providing Patient Incentives for Complying with Medical Treatments

(71) Applicant: Carespeak Communications, Inc., East Brunswick, NJ (US)

(72) Inventor: Srdjan Loncar, East Brunswick, NJ (US)

(73) Assignee: Carespeak Communications, Inc., East Brunswick, NJ (US)

(21) Appl. No.: 13/691,161

(22) Filed: Nov. 30, 2012

Related U.S. Application Data
(60) Provisional application No. 61/565,661, filed on Dec. 1, 2011.

(51) Int. Cl. G06Q 50/22

(52) U.S. Cl. CPC G06Q 50/22
USPC 705/2

(57) ABSTRACT

Systems and methods of providing an incentive to a patient for self-reported compliance may include receiving, by a processor, one or more inputs from a patient. The one or more inputs may correspond to a self-reporting regimen. The systems and methods may further include recording, by the processor, the one or more inputs to a database and analyzing, by the processor, the database to determine whether the one or more inputs meet or exceed a threshold. If the threshold is met or exceeded, the systems and methods may further include providing, by the processor, one or more incentives to the patient.

### CROSS REFERENCE TO RELATED APPLICATIONS

This application claims the benefit of priority to U.S. Provisional Patent Application 61/565,661, filed Dec. 1, 2011, and entitled “METHOD FOR PROVIDING PATIENT INCENTIVES FOR COMPLYING WITH MEDICAL TREATMENTS,” the entire contents of which are hereby incorporated by reference.

### BACKGROUND

It is estimated that about 25% to 33% of prescriptions written by physicians are never filled by patients. It is further estimated that up to 75% of patients stop taking their medication within the first year of prescription. Furthermore, about half of those that remain fail to refill their prescriptions. These represent a significant contribution to medication therapy non-compliance that can potentially lead to a deteriorating health of patients, increased costs to the healthcare system, increased costs to employers due to employee sick days, missed revenues for pharmaceutical companies, missed revenues for retail pharmacies and other additional expenses. Similarly, other aspects of medical treatment plans may be ignored by patients. For example, patients may frequently skip doses of medication, forget or choose not to record biometric data such as blood pressure, miss doctor office visits or lab tests and other items included in a medical treatment plan.

Recently, various e-commerce and other similar vendors have begun incentive programs for customers or other users to receive a small reward or token for completing a task. For example, an online retailer may provide customers with a certain percentage off their next purchase if certain tasks such as providing a review of a vendor or item are completed. However, these incentive programs are typically limited to retail environments where the tasks completed by the customers are for the benefit of the retail environment (e.g., providing a review of an item available for purchase), and not for the specific benefit of the customer.

### SUMMARY

In an embodiment, a method of providing an incentive to a patient for self-reported compliance may include receiving, by a processor, one or more inputs from a patient. The one or more inputs may correspond to a self-reporting regimen. The method may further include recording, by the processor, the one or more inputs to a database and analyzing, by the processor, the database to determine whether the one or more inputs meet or exceed a threshold. If the threshold is met or exceeded, the method may further include providing, by the processor, one or more incentives to the patient.

In an embodiment, a system for of providing an incentive to a patient for self-reported compliance may include a processor and a non-transitory, processor-readable storage medium in communication with the processor. The non-transitory, processor-readable storage medium may contain one or more programming instructions that, when executed, cause the processor to receive one or more inputs from a patient. The one or more inputs may correspond to a self-reporting regimen. The one or more programming instructions that, when executed, may further cause the processor to record the one or more inputs to a database, analyze the database to determine whether the one or more inputs meet or exceed a threshold and if the threshold is met or exceeded, provide one or more incentives to the patient.

### BRIEF DESCRIPTION OF THE DRAWINGS

FIG. 1 depicts a flow diagram of a method that may be used to initialize a patient account for obtaining incentives according to an embodiment.

FIG. 2 depicts a flow diagram of a method of monitoring patient treatment, collecting inputs and providing incentives according to an embodiment.

FIGS. 3A-3E depict various illustrative screenshots of a software application that may be used to provide access to an account according to an embodiment.

FIG. 4 depicts a block diagram of communications between one or more electronic devices and one or more computing devices according to an embodiment.

FIG. 5 depicts a block diagram of illustrative internal hardware that may be used to contain or implement program instructions according to various embodiments.

FIG. 6 depicts a schematic for a first incentive process according to an embodiment.

FIG. 7 depicts a schematic for a second incentive process according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated and designed in a wide variety of different configurations, all of which are explicitly contemplated herein.

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “electronic device” refers to a device, such as, for example, a mobile device, a computing device, a server and one or more components thereof. In some embodiments, the electronic device includes a processor and a tangible, non-transitory, computer-readable memory. The memory may contain programming instructions that, when executed by the processor, cause the computing device to perform one or more operations according to the programming instructions. In some embodiments, the electronic device may be connected to a communications network, such as, for example, the Internet, an intranet, a personal area network, a home area network, a storage area network, a campus area network, a backbone network, a metropolitan area network, a wide area network, a virtual private network and/or the like.

A “mobile device” refers to an electronic device that is generally portable in size and nature. Accordingly, a user may transport a mobile device with relative ease. Examples of mobile devices include, but are not limited to, pagers, cellular phones, feature phones, smartphones, personal digital assistants (PDAs), cameras, tablet computers, phone-tablet hybrid devices (e.g., “phablets”), laptop computers, netbooks, ultrabooks, global positioning satellite (GPS) navigation devices, in-dash automotive components, media players, watches, handheld imaging devices, personal medical devices and/or the like. The mobile device may be optionally preloaded with a plurality of programming instructions that restrict use of certain features and/or functions of the mobile device, as will be described in greater detail herein. The mobile device may be provided to a patient in exchange for the patient's agreement to comply with certain terms and/or conditions, as described herein.

A “computing device” is an electronic device and/or a mobile device, such as, for example, a computer or components thereof. The computing device may generally contain a memory or other storage device for housing programming instructions, data or information regarding a plurality of applications, data or information regarding a plurality of electronic devices and/or the like. The programming instructions may be in the form of an application environment, as described in greater detail herein, and/or contain one or more modules, such as software modules for carrying out tasks as described in greater detail herein. The data may optionally be contained on a database, which is stored in the memory or other storage device. The data may optionally be secured by any method now known or later developed for securing data. The computing device may further be in operable communication with one or more electronic devices. The communication between the computing device and each of the one or more electronic devices may further be secured by any method now known or later developed for securing transmissions or other forms of communication.

A “server” is a computing device or component thereof that generally provides data storage capabilities for one or more computing devices. The server can be independently operable from other computing devices and may optionally be configured to store data in a database, a memory or other storage device. The server may optionally contain one or more programming instructions, such as programming instructions in the form of the operating environment, as described in greater detail herein, and/or one or more modules, such as software modules for carrying out processes as described in greater detail herein. The server may have one or more security features to ensure the security of data stored within the memory or other storage device. Examples of security features may include, but are not limited to, encryption features, authentication features, password protection features, redundant data features and/or any other security features now known or later developed. The server may optionally be in operable communication with any of the electronic devices and/or computing devices described herein and may further be secured by any method now known or later developed for securing transmissions or other forms of communication.

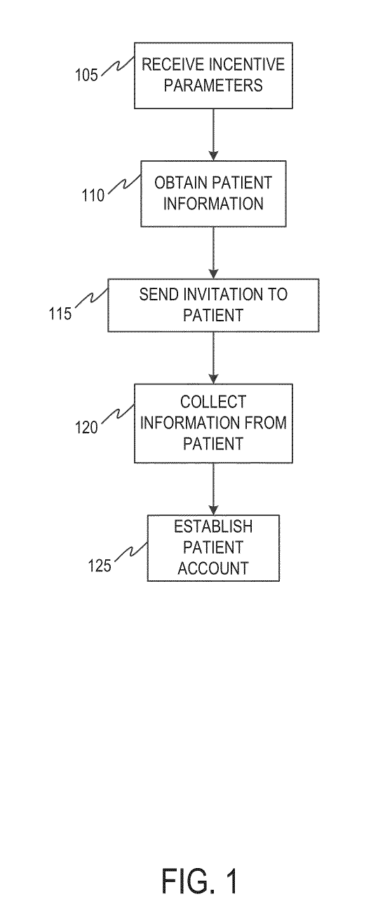

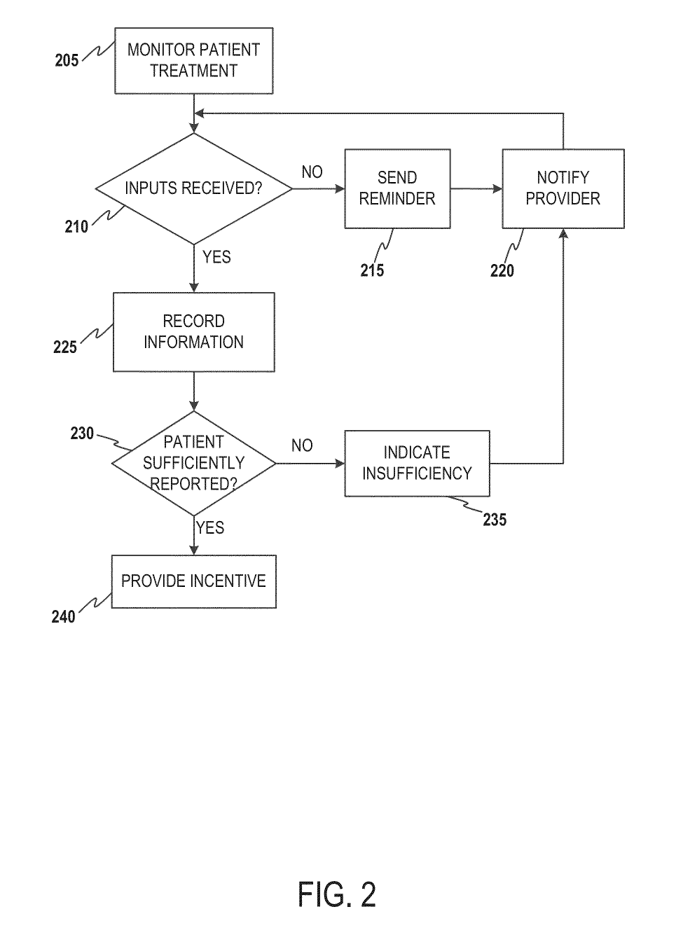

An “application environment” is an embodiment of programming instructions that direct the various components of each electronic device to execute a plurality of operations, such as, for example, those described in more detail in reference to FIGS. 1 and 2. The application environment may generally provide a means for communicating with one or more electronic devices, whether or not explicitly described herein, a means for obtaining data, a means for compiling data, a means for organizing data, a means for transmitting data, a means for performing calculations and a means for completing other tasks, as may be described in greater detail herein.

“Compliance” or “self-reported compliance” refers to one or more acts under a self-reporting regimen performed by a patient where the patient reports various tasks completed related to a medical treatment plan. Tasks may include reporting measured biometric values, reporting observed daily living values, reporting medication intake, reporting attendance to scheduled medical appointments and other related data reported to an individual healthcare account. The patient may report the various tasks via any means of electronic communication now known or later developed, including, for example, email, voice mail, text messaging such short message services (SMS), multimedia messaging services (MMS) and the like, general packet radio service (GPRS) messages, extended messaging services (XMS) and other similar electronic communication techniques. Compliance may be calculated as a percentage, where the number of actual self-reports is divided by the number of expected self-reports. The expected self-reports correspond to intervals for when a patient is directed to complete a task. For example, if a medication is prescribed to be taken 3 times a day (e.g., at breakfast, lunch and dinner), then 3 expected self-reports for that medication are expected every day.

An “incentive” refers to a discretionary reward that may motivate or encourage a patient to comply with one or more self-reporting parameters. An example of an incentive may include, but is not limited to, a coupon for a free item, a coupon for a free service, a coupon for a discount on an item, a coupon for a discount on a service, a free prescription refill, a discounted prescription refill, a waived co-pay, points that can be accrued and redeemed for products, points that can be accrued and redeemed for services, a cash back amount, a credit amount and access to features on an electronic device, as described in greater detail herein.

The present disclosure is directed to a module integrated within a healthcare platform such as the CareSpeak mHealth platform discussed in U.S. Pat. No. 7,956,727 filed Mar. 24, 2008, the content of which is hereby incorporated by reference in its entirety. In one embodiment, the module may be directed to an incentive system for improving self-reported tasks included in a medical treatment plan. Various types of compliance incentives may be provided to a patient for complying and self-reporting the tasks completed in the medical treatment plan.

FIG. 1 depicts a flow diagram of a method that may be used to initialize a patient account for obtaining incentives according to an embodiment. The embodiment depicted herein is merely illustrative, and those skilled in the art will recognize that other methods may be used without departing from the scope of this disclosure. In various embodiments, the method described herein may be completed with an electronic device, a computing device, a mobile device, a server and/or the like. For purposes of simplicity, the following description will refer to a computing device. The computing device may receive 105 one or more incentive parameters. The incentive parameters may generally outline the details of an incentive program, as is discussed in greater detail herein. In some embodiments, the incentive program may include a discount of medical co-pay requirements, a discount on a medical deductible and/or out of pocket maximum requirements, a rewards card with a redeemable balance for products and/or services, product discounts, coupons and/or the like. The incentive program may further outline the types of incentives that are available for each patient, specific medications for which one or more incentives apply, frequency of incentives and/or the like. The incentive program may further outline requirements for obtaining incentives, including, but not limited to, timely patient replies to requests for information, patient inputs of information regarding prescription medication use, information received from other sources regarding prescription medication use by a patient, information regarding whether prescription medication is being timely refilled and information regarding whether a patient is making and/or keeping regularly scheduled appointments. In some embodiments, the incentive parameters may further include obtaining information regarding a mobile device, such as, for example, usage data, manufacturer and/or model of mobile device and/or service plan features such as data service, text message service, telephone service and/or the like. Other examples of incentive parameters may include, but are not limited to, one way and/or two way SMS or MMS messaging information, outbound and/or inbound voice calling information, one way and/or two way email messaging information, general web access information, specific web site access permissions and/or restrictions, access permissions and/or restrictions of specific telephone numbers, short-codes, long-codes and access permissions and/or restrictions to specific phone features and functionalities such as emailing, texting, web browsing, peripheral use and/or the like. The incentive parameters may be received from any entity, including, but not limited to, a medical services provider, a program manager, a clinician, a medical staff person and an administrator. The program manager may generally be an entity that provides and maintains the program and services discussed herein.

In various embodiments, the computing device may obtain 110 patient information. In some embodiments, the computing device may obtain 110 patient information at the same time it receives 105 incentive parameters. In particular embodiments, the computing device may obtain 110 patient information as a subset of receiving 105 incentive parameters. In other embodiments, the computing device may obtain 110 patient information separately from receiving 105 incentive parameters. The patient information may include a list of patients that are potential candidates for the incentive program. The list may include any type of patient identifying information, including, but not limited to, name, address, telephone number, email address, mobile number, social security number, age and birthdate. The list may further include other pertinent information for the incentive program, including a patient's health records, a patient's medical history, past and present physicians used by the patient, past and present pharmacists used by the patients, medications currently taken by the patient (both prescription and over-the-counter), medications previously taken by the patient (both prescription and over-the-counter), the patient's biometric data and/or the like. In some embodiments, the list may generally include only patients that are determined to be a potential candidate for the incentive program. A patient may be a potential candidate if he/she is referred to the incentive program by a medical services provider, a program manager, a clinician, a medical staff person, an administrator and/or the like. In certain embodiments, the incentive parameters previously described herein may be individualized for each patient to be enrolled. In other embodiments, the incentive parameters may be generalized for all patients to be enrolled.

In various embodiments, the computing device may send 115 an invitation to a patient. The invitation may generally be sent only to patients who are on the list of patients previously described herein. In some embodiments, as an alternative to the computing device sending 115 an invitation to a patient, the patient may receive an invitation from another entity, such as, for example, a medical services provider, a program manager, a clinician, a medical staff person and an administrator. In some embodiments, the invitation may be electronically transmitted to the patient. Examples of electronic transmission include, but are not limited to, SMS, MMS, email, XMS, GPRS messaging, facsimile transmission and/or the like. In other embodiments, the invitation may be transmitted to the patient via other means. Examples of other means may be, for example, postal mail, providing a written invitation in person, telling a patient in person, calling a patient, leaving a voicemail for a patient and/or the like. The invitation may generally contain information and/or instructions for the patient to follow regarding setting up an account. In some embodiments, the invitation may include a link to a website, a link to a server, an URL-shortening link and/or the like. The link may be a customized link that is only valid for a single patient, or may be a general link that any individual may use to sign up for an account. In other embodiments, the invitation may include instructions for sending a text message to set up an account. In other embodiments, the invitation may include instructions for sending an email to set up an account.

In alternative embodiments, the computing device may provide authorization for an electronic device, such as a mobile device, to be sent to the patient instead of, or in addition to, an invitation. The mobile device may contain one or more programming instructions that restrict the patient's use of the mobile device unless one or more tasks are completed. In some embodiments, the one or more programming instructions may restrict certain features of the device. Examples of features that may be restricted include, but are not limited to, access to a certain number of contacts, ability to send/receive telephone calls, ability to send/receive text messages, ability to access the Internet, ability to access certain software applications such as games, utilities, productivity applications and the like, ability to download software applications, and/or ability to use device peripherals such as a camera, a removable media drive and/or the like. For example, the one or more programming instructions may prevent all features of the mobile device from functioning until the computing device has collected information from the patient, as described hereinafter. In another example, the one or more programming instructions may restrict the number of contacts that the patient is allowed to communicate with using the mobile device until sufficient reporting information is received, as described in greater detail herein.

In some embodiments, no invitation may be sent. Rather, the patient is automatically enrolled when the computing device obtains 110 the patient information. In these embodiments, the computing device may optionally send a notification to the patient that he/she has been enrolled.

In various embodiments, the computing device may collect 120 information from the patient. The information may generally be related to registration for setting up an account, as previously described herein. Examples of information may include, but are not limited to, patient name, address, telephone number, email, mobile number, birthdate, medical history, primary physician information, insurance coverage information, desired username and/or password, desired method of contact and/or the like. In some embodiments, the computing device may collect 120 information via any text-based communication now known or later developed, including, but not limited to, email, SMS messaging, MMS messaging, GPRS messaging, facsimile messaging and/or the like. In other embodiments, the computing device may collect 120 information via a form, such as a web-based form and/or a paper based form. In other embodiments, the computing device may collect 120 information via voice entry, which may use an automated system for detecting and recording voice entries or a person to translate voice entries into text. The information may be collected from the patient, a medical care provider, a family member of the patient, a third party such as an insurance provider and/or the like.

In various embodiments, the computing device may establish 125 a patient account once the patient information has been collected. The computing device may generally establish 125 the patient account by, for example, verifying that patient information sufficient to establish the account has been collected, registering a user name and/or password, registering an email address, registering a mobile number and/or the like. Once the computing device has established 125 the patient account, the computing device may be able to complete other processes described hereinafter.

FIG. 2 depicts a flow diagram of a method of monitoring patient treatment, collecting inputs and providing incentives according to an embodiment. In various embodiments, the computing device may monitor 205 patient treatment. This may be completed by any method of monitoring now known or later developed, including, but not limited to, monitoring electronic health records, receiving inputs from the patient, receiving inputs from the patient's medical care provider, receiving inputs from a family member of the patient, receiving inputs from an authorized person, receiving inputs from third parties, receiving inputs from automated reporting devices and/or the like. In some embodiments, the monitoring 205 may include collecting information regarding the patient's medical history, including, but not limited to, treatments received, prescriptions received, whether the patient has filled a prescription, whether the patient has refilled the prescription, whether the patient filled a prescription within a specified period of time, whether the patient refilled a prescription within a specified period of time and/or the like.

In various embodiments, the computing device may determine whether inputs are received 210. As previously described, inputs may be received from the patient, a medical service provider, a patient's family member, a person authorized by the patient to provide reporting information, a third party, automated reporting devices and/or the like. The inputs may generally be related to reporting information previously described herein, including, but not limited to, medical history, prescription information and/or the like. In some embodiments, inputs may be determined to not have been received 210 if no input is received within a specified due date. In other embodiments, inputs may be determined to not have been received 210 if no input is received after a period of time has passed since the last input was received from a user. In other embodiments, inputs may be determined to not have been received 210 if no input is received within a period of time after the patient account initialization has been completed according to FIG. 1. The period of time is not limited by this disclosure and may include, for example, a day, a week, two weeks, a month, two months, three months, six months, 12 months, 18 months, 2 years and the like. In certain embodiments, the period of time may correspond to a period upon which the patient would need to refill a prescription if the medication is taken at the prescribed intervals. The computing device may continuously receive inputs and may complete other processes described herein upon each reception of inputs.

In various embodiments, if no inputs are received, the computing device may optionally send 215 a reminder to the patient and/or persons designated by the patient to receive reminders. The reminder is not limited by this disclosure and may be, for example, a text message, an email message, a pop-up message, a telephone call, a facsimile transmission, a mailed letter and/or the like. Likewise, the contents of the reminder are also not limited by this disclosure and may include, for example, a reminder message to the patient that no inputs have been received, a schedule of due dates and/or the like, a record of previous inputs received, contact information, support information and/or the like. In some embodiments, the reminder may include a link, such as an URL for a website, for the patient to use to input information. In other embodiments where the patient has a mobile device that contains programming instructions that can restrict certain functions as described herein, the reminder may further include a warning that certain features will be locked and/or forfeited if inputs are not provided. The warning may include, for example, a time period that the patient has to comply. As an alternative to a warning, the reminder may include programming instructions that direct the mobile device to deactivate certain features and a message may be displayed that instructs the patient on the steps that must be taken to regain access to the features.

In various embodiments, the computing device may optionally notify 220 a provider of the failure to receive inputs. The notification is not limited by this disclosure and may be, for example, a text message, an email message, a telephone call, a facsimile transmission, a mailed letter and/or the like. Likewise, the contents of the notification are also not limited by this disclosure and may include, for example, a reminder message to the provider that no inputs have been received, a schedule of due dates and/or the like, a record of previous inputs received, contact information, support information and/or the like.

Once the computing device optionally sends 215 a reminder and/or notifies 220 a provider, it may return to step 210 to determine whether inputs have been received. In various embodiments, if inputs are received, the computing device may record 225 information that corresponds to the inputs. The information may be recorded, for example, in a database. The information that is recorded 225 is not limited by this disclosure, and may include, for example, information regarding patient's prescription history, whether the patient has been taking his/her prescribed medication, whether the patient has been refilling his/her prescribed medication, whether the patient has been attending regularly scheduled appointments, whether the patient has been regularly recording biometric data and/or the like. In some embodiments, the device may optionally verify that the inputs are correct. Verification that the inputs are correct may include, for example, checking to see if the patient entered all of the required information, verifying that the inputs comply with certain parameters that prevent the patient from gaming or scamming the reporting, and/or the like.

In various embodiments, the computing device may determine whether the patient has sufficiently reported 230 information by analyzing the inputs stored in the database and determining whether they meet a threshold. In some embodiments, the computing device may calculate whether the patient has met the threshold by dividing the number of inputs provided by the patient by the number of expected inputs to be provided by the patient. The threshold is a specific percentage is not limited by this disclosure, and may include, for example, about 50%, about 55%, about 60%, about 65%, about 70%, about 75%, about 80%, about 85%, about 90% and about 90%. In some embodiments, the calculating may be completed on a rolling basis where it is determined what the percentage is each time an input is received. In other embodiments, the specific percentage may be calculated after a period of time has elapsed and/or a number of expected occurrences has occurred. The period of time may be, for example, 1 week, 2 weeks, 1 month, 2 months 3 months, 6 months, 9 months, 1 year, 2 years and the like. The number of expected occurrences may be, for example, 5 occurrences, 10 occurrences, 15 occurrences, 20 occurrences, 30 occurrences, 50 occurrences and 100 occurrences. In one illustrative example, if a patient's prescription requires a monthly refill, the computing device may be configured to expect an input every month upon the patient refilling the prescription. The computing device may determine that, after a 12 month period, if an input was received at least 9 times, the patient has sufficiently reported 230.

In various embodiments, if the computing device determines that the patient has not sufficiently reported 230 information, the computing device may optionally indicate 235 the insufficiency. The insufficiency may be indicated 235 to the patient, the patient's designated family members and/or representatives, other third parties such as insurance carriers and/or the like. The indication is not limited by this disclosure and may be, for example, a text message, an email message, a telephone call, a facsimile transmission, a mailed letter and/or the like. Likewise, the contents of the indication are also not limited by this disclosure and may include, for example, a reminder message that insufficient inputs have been received, a schedule of due dates and/or the like, a record of previous inputs received, contact information, support information and/or the like. In some embodiments, the indication may include a link, such as an URL for a website, for the patient to use to input information. In various embodiments, the computing device may notify 220 the provider and return to monitoring, receiving and recording inputs.

In various embodiments, if the computing device determines that the patient sufficiently reported 230 information, the computing device may provide 240 an incentive to the patient. In some embodiments, the computing device may provide 240 the incentive by any means of communication, such as, for example, a text message, an email message, a telephone call, a facsimile transmission, a mailed coupon and/or the like. In some embodiments, the computing device may provide 240 the incentive by crediting an account of the patient's with an incentive. The account is not limited by this disclosure, and may include, for example, a credit account, a debit account, a rewards account, a frequent shopper account, a store-linked account, a health insurance account and/or the like. The incentive may include, for example, a coupon for a free item and/or service, a coupon for a discount on an item and/or a service, a free prescription refill, a discounted prescription refill, a waived co-pay, points that can be accrued and redeemed for products and/or services, a cash back amount, a credit amount and/or the like. In some embodiments, the degree of incentive may correlate to the percentage of reported information from the patient. In an illustrative example, a patient may be eligible for extra incentives for providing inputs 100% of the time, whereas he/she may receive a reduced incentive for providing inputs 75% of the time. In other embodiments in which the patient possesses a mobile device with programming instructions that restrict access to certain features as described herein, the computing device may provide 240 the incentive by providing unlocking instructions and/or the like to the patient's mobile device to allow the patient to access a greater number of features. For example, the computing device may provide 240 the incentive by allowing the mobile device to access additional contact information, use web-based features, send/receive text messages, send/receive telephone calls, download applications and/or the like.

In some embodiments, the processes described in FIG. 2 may repeat any number of times until an incentive is received. In other embodiments, the processes described in FIG. 2 may repeat any number of times regardless of whether an incentive is received to allow for a patient to obtain multiple incentives. In certain embodiments, the patient may only be allowed to obtain a specific number of incentives before the process ends. An example of the specific number of incentives may include, but is not limited to, 3 incentives, 5 incentives, 10 incentives, 15 incentives and 20 incentives. In other embodiments, the processes described in FIG. 2 may repeat a set number of times, regardless of whether incentives were received. In other embodiments, the processes described in FIG. 2 may end if no incentive is received after a set number of repeats.

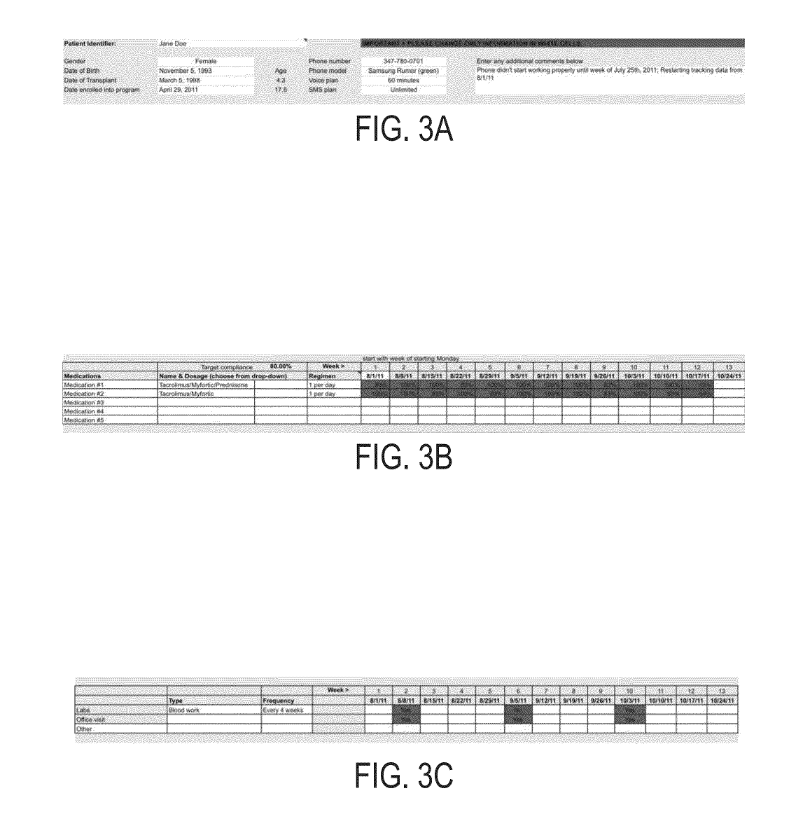

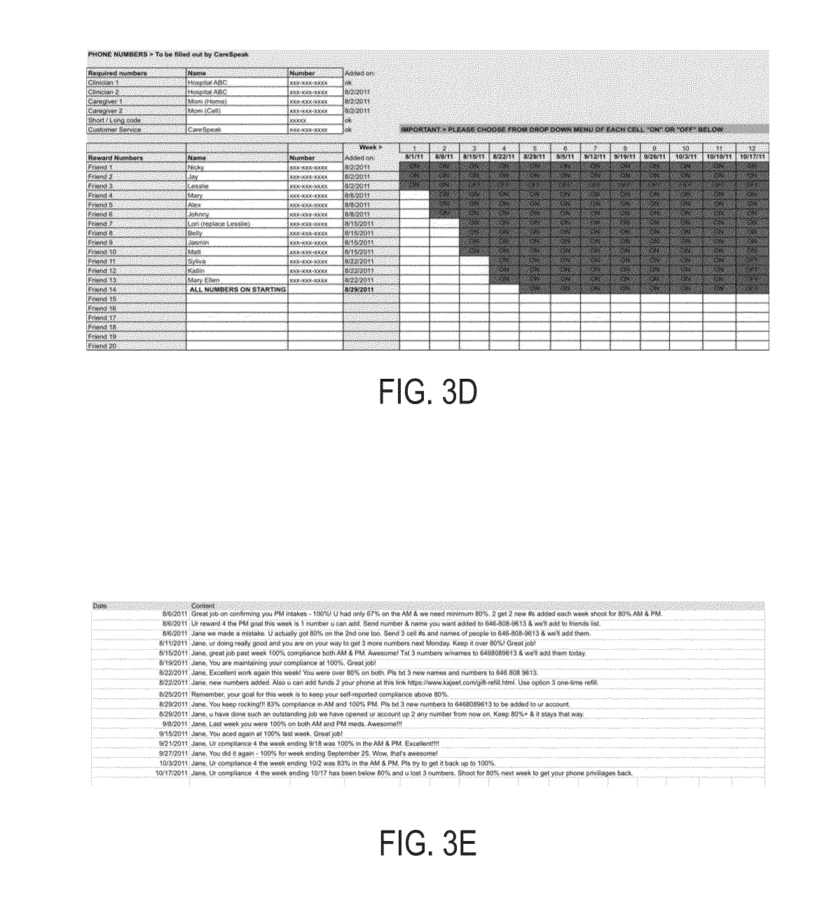

As shown in FIGS. 3A-3E, the computing device may provide an interface for access to any information relating to the patient's account, medical records, prescription history, registered account information, input history and/or the like. The interface may be an application on an electronic device, a web-based interface and/or the like. The interface may be used by any entity, including, but not limited to, the patient, a caretaker, a medical services provider, a staff member, an assistant, a program manager, an administrator, an insurance company employee, and/or the like.

FIG. 3A depicts an illustrative screenshot for identifying a patient and his/her account information according to an embodiment. The information may include the patient's name, demographic information, specific treatment information, information related to the mobile device and/or the like. In some embodiments, the information may further include additional comments related to the patient that may be entered by a physician, a medical services provider, authorized persons, other third parties, program managers (PM) and/or the like.

FIG. 3B depicts an illustrative screenshot of a medication schedule for a patient. The medication schedule may include, for example, a list of all medications a patient is to take, an accompanying regimen for each medication and one or more self-reported compliance entries for taking each medication over a period of time. In some embodiments, various fields may be shaded accordingly to represent the patient's compliance. In certain embodiments, a field may be colored red if the patient failed to meet a compliance level. Conversely, in certain embodiments, the field may be colored green if the patient met a compliance level.

FIG. 3C depicts an illustrative screenshot of an appointment calendar for a patient. The appointment calendar may include, for example, one or more doctor appointments, one or more lab appointments and/or one or more other appointments for a patient. In some embodiments, the patient's compliance may be tracked on the calendar, where the calendar is marked for instances in which the patient kept his/her appointment and/or the patient did not keep his/her appointment. For example, a missed appointment may be colored red. Conversely, the appointments the patient did attend may be colored green. The patient may additionally be rewarded for attending appointments and/or penalized for missing appointments, as described in greater detail herein.

FIG. 3D depicts an illustrative screenshot of a patient's communication settings. These settings may include, for example, a plurality of numbers to which an electronic device may access, a status indicator for each number and/or the like. In some embodiments, each number may be set to “On” or “Off”. When a number is set to “On”, the electronic device may access the number without any restrictions. Conversely, when a number is set to “Off”, the electronic device may be restricted from accessing the number. In certain embodiments, some numbers may always be set to “On”, such as, for example, healthcare providers, caregivers, emergency numbers such as 911, healthcare platforms and/or the like. In some embodiments, some numbers, such as friends, family and other acquaintances of the patient may be variably turned “On” or “Off” depending on the patient's level of compliance as discussed herein.

FIG. 3E depicts an illustrative screenshot of one or messages that may be sent to a patient. The one or more messages are not limited by this disclosure, and may include, for example, notifications regarding status, notification regarding compliance, motivational messages, educational messages and/or the like.

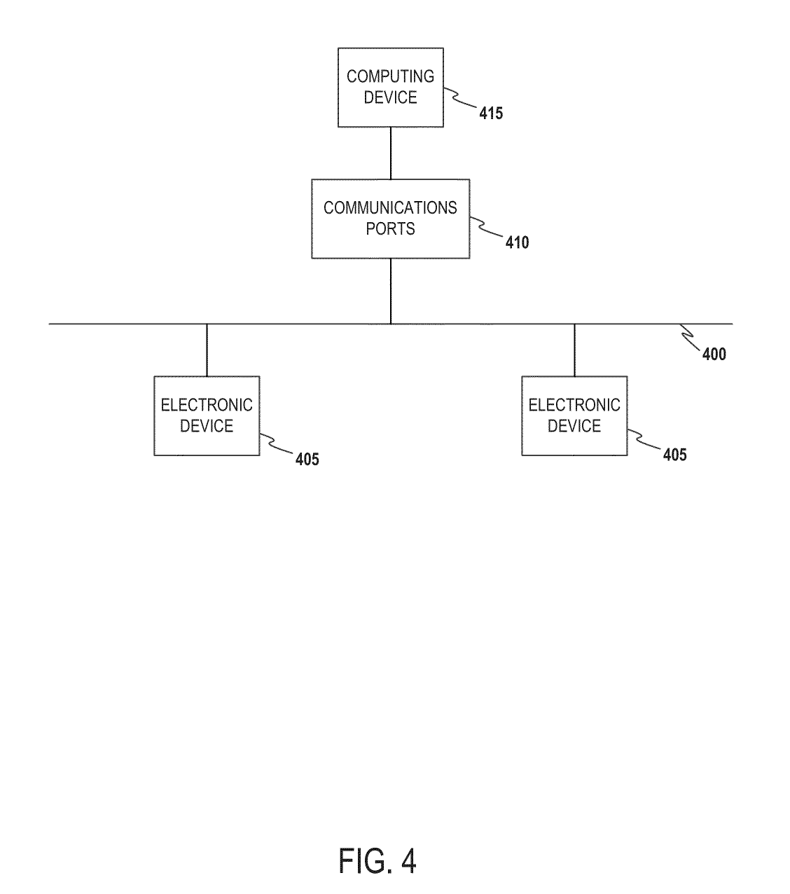

FIG. 4 depicts a block diagram of communications between one or more electronic devices and one or more computing devices according to an embodiment. In this embodiment, the electronic devices may generally be used by one or more patients, whereas the computing device is maintained by another entity such as a program manager (PM) and/or the like. A communications network 400 may serve as an information highway interconnecting the other illustrated components. The communications network is not limited by this disclosure, and may include any communications network now known or later developed. Examples of communications networks may include, but are not limited to, the Internet, intranets, wired networks and wireless networks. One or more electronic devices 405, such as mobile devices, computing devices and the like may connect to the communications network 400. In embodiments where a plurality of electronic devices 405 are connected to the communications network 400, each electronic device 405 may be configured to communicate with other electronic devices via the communications network 400. A computing device 415 may also be connected to the communications network 400, and may optionally connect through the use of one or more communications ports 410.

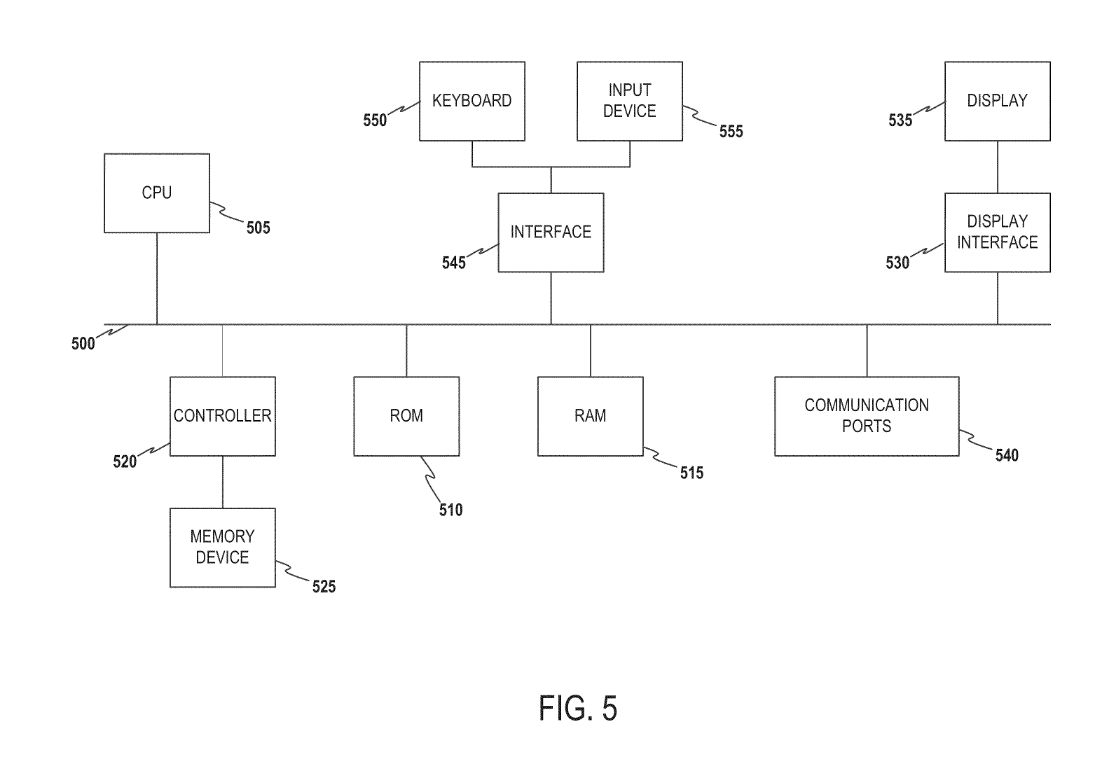

FIG. 5 depicts a block diagram of illustrative internal hardware that may be used to contain or implement program instructions, such as the process steps discussed herein in reference to FIGS. 1-2, according to embodiments. A bus 500 serves as the main information highway interconnecting the other illustrated components of the hardware. CPU 505 is the central processing unit of the system, performing calculations and logic operations required to execute a program. The CPU 505, alone or in conjunction with one or more of the other elements disclosed in FIG. 5, is an illustrative processing device, computing device or processor as such terms are used within this disclosure. Read only memory (ROM) 510 and random access memory (RAM) 515 constitute illustrative memory devices (i.e., processor-readable non-transitory storage media).

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 510 and/or the RAM 515. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 530 may permit information from the bus 500 to be displayed on the display 535 in audio, visual, graphic or alphanumeric format. Communication with external devices, such as a print device, may occur using various communication ports 540. An illustrative communication port 540 may be attached to a communications network, such as the Internet or an intranet.

The hardware may also include an interface 545 which allows for receipt of data from input devices such as a keyboard 550 or other input device 555 such as a mouse, a joystick, a touch screen, a remote control, a pointing device, a video input device and/or an audio input device.

The various embodiments may be realized in the specific examples found below.

### Example 1

### Mobile Phone Usage Based on Compliance

One incentive system may be providing the usage of a mobile phone, including the phone and service plan features (e.g. web browsing, texting, calling, etc.), dependent on the patient's compliance with a prescribed therapy regimen or other requirements set by a program manager (PM), such as reporting of biometric or other data in regular/predetermined or ad-hoc intervals. The PM (e.g., a clinician, medical staff, administrator, etc.) may set up the incentive parameters for a program that may include a large number of users, a group of users or an individual user. Each user may receive a mobile phone for his/her own personal use, where the features of the phone are added or removed depending on the level of compliance. Various incentive parameters may be, but are not limited to, the following functionalities of the mobile phone and/or carrier plan:
One and/or two-way SMS or MMS
Outbound and inbound voice calling
One and/or two-way e-mailing
General web access, or specific web site (URL) access permission and/or restriction
Access permission and/or restriction on certain phone numbers (individual and/or user groups), short-codes and/or long-codes.
Access permission and/or restriction to certain phone features and functionalities such as e-mailing, texting, web browsing, camera (video and photo), location-based services and others.

Incentive parameters may be dependent on patients meeting goals or performing tasks set by a Program Administrator. These goals and/or tasks can be, but are not limited to, the following:
Meet and/or exceed specific goals for self-reported compliance of medication intakes within a specified period of time.
Meet and/or exceed specific goals for reporting biometric data within or outside specified periods of time.
Attending scheduled appointments, such as, for example, doctor's office visits, therapy sessions and/or the like.
Achieving laboratory-verified goals such as, for example, meeting a blood glucose goal, meeting a cholesterol level goal and/or the like.

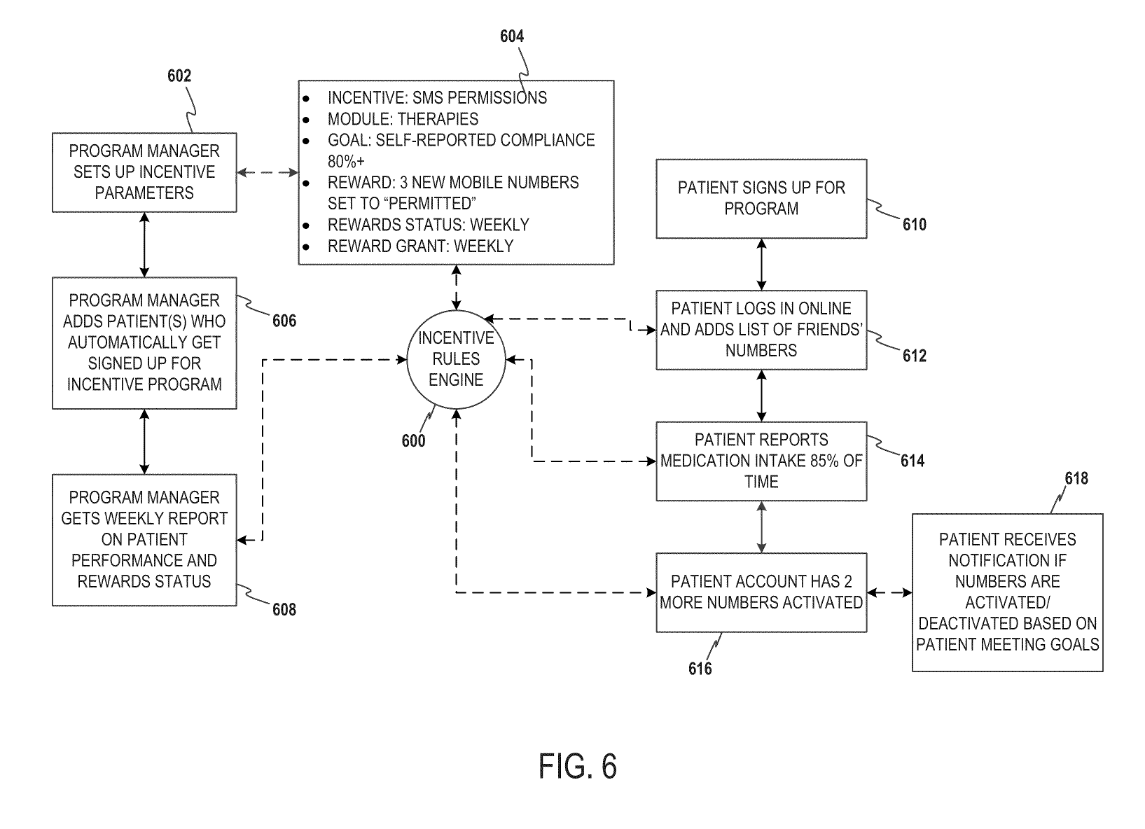

FIG. 6 depicts an illustrative patient sign-up process and how a program manager and a patient may interact with an incentive rules engine 600. An objective may be to engage the patient while reducing the amount of work and steps to be performed by a PM to sign up a patient.

Initially, the PM may set up 602 a listing 604 of incentive parameters. The listing 604 of incentive parameters may include various individualized parameters and goals for a particular patient. For example, the listing 604 may include incentives available, medications the incentives apply to, rewards, reward status messaging frequency, and other various parameters. The PM may also add 606 patient(s) who will automatically get signed up for the incentive program. As the program progresses, the PM may receive 608 a weekly (or another regular time period such as monthly) report on patient performance from the incentive rules engine 600.

A patient may sign up 610 for the program by accepting an invitation from their healthcare platform system or healthcare provider, or by various other means. The patient may log in 612 online to access their patient record to add list of friends numbers related to specific incentives the patient may achieve. Alternatively, the patient may enter the numbers via text messaging from a mobile device that is provided to the patient with features that can be locked and unlocked. Throughout their treatment process, the patient may report 614 their medication intake. In this example, the patient reports 614 their medication intake 85% of the time. The rules engine 600 may check the listing 604 of parameters and determine the patient is required to report 80% of the time, and thus determines the user has satisfied the incentive. As such, the incentive rules engine 600 may add 616 three new numbers to the patient's allowed number list, thereby adding to the functionality of the mobile device. The patient may receive 618 a notification indicating the numbers have been activated. Conversely, if the user does not meet the incentive goal, the patient may receive 618 a notification indicating various numbers have been deactivated, thereby removing some functionality of the mobile device.

Additional steps may be included or removed from the process. For example, the process may include an Add Rule step for the PM where the PM may define if numbers from the patient's family and friends list will be added randomly, or according to a specific sequence as defined by the patient, OPM, caregiver, or other person associated with the patient. Similarly, the process may include a Delete Rule step where the PM, or another administrator, may define how numbers will be deleted from the allowed list if the patient does not meet the incentive goals. The numbers from the patient's family and friends list may be deleted randomly, or according to a specific sequence as defined by the patient, PM, caregiver, or according to usage (e.g., most used number is deleted first).

One illustrative incentive may be adding numbers to an allowed-to-dial list associated with the patient's mobile phone. This adding of numbers may be completed on the mobile phone or on a web interface, such as the interface previously described herein. The following illustrative message listing may describe the exchange of messages between the healthcare platform and the patient. Messages coming from the healthcare provider system are indicated by MT (mobile terminal), and messages from the patient are indicated by MO (mobile originator). After reaching their compliance goal, a patient may send and/or receive one or more messages to/from the healthcare platform system. Examples of such messages may include:
MT: [name] your compliance for [medication name/dosage] for week ending [date] is 83%. Great job!
MT: You can now add [number] new phone numbers. Respond with ADD name and numbers to add with no spaces/dots/dashes (e.g. ADD JOHN@555222333 MARY@2352526565).
MO: ADD JOHN5552223333
MT: John @ 555-222-3333 has been added to your Allowed List

If the patient tries to add more numbers than is permitted for the time period, the response message may be:
MT: Sorry but you have already added maximum number 3 of contacts for this period.

If the patient mistakenly adds a number and wants to change it, the patient may do so X number of times during that period by sending a message to system, wherein X is determined by the healthcare platform system or PM. An illustrative message exchange may be:
MO: DELETE 5552223333
MT: John @ 555-222-3333 has been deleted. You can add 1 number.
MO: ADD Mike@5557771111
MT: Mike @ 555-777-1111 has been added.

The PM may restrict how many times this deletion/substitution may be done. The PM may also set up a rule that, after a specified period of time where goal has been consecutively met, all restrictions are lifted until the patient misses a goal. At that time, all restrictions may be reset to the settings that were active last time the patient had restrictions.

If the patient's compliance goal is below the threshold set by the PM at the end of the period (e.g. week), the patient may lose numbers from the Allowed List. An illustrative message exchange may be:
MT: [name] your compliance for [medication & dosage] for week ending [date] is 51%.
MT: You have lost use of Jerry@555-333-4444, Mike@222-777-1111, John@555-222-3333
MT: To get back numbers reach your goal of 80% next week.

Just as a patient may earn or lose usage of certain numbers from their Allowed list, the patient may earn or lose usage of web browsing, and/or other features on the phone.

It should be noted the details discussed above in regard to the mobile phone incentive program are by way of example only to show one incentive program. The details may be changed and/or modified depending on the capabilities and functionality of an individual healthcare platform system.

### Example 2

### Monitoring Blood Glucose

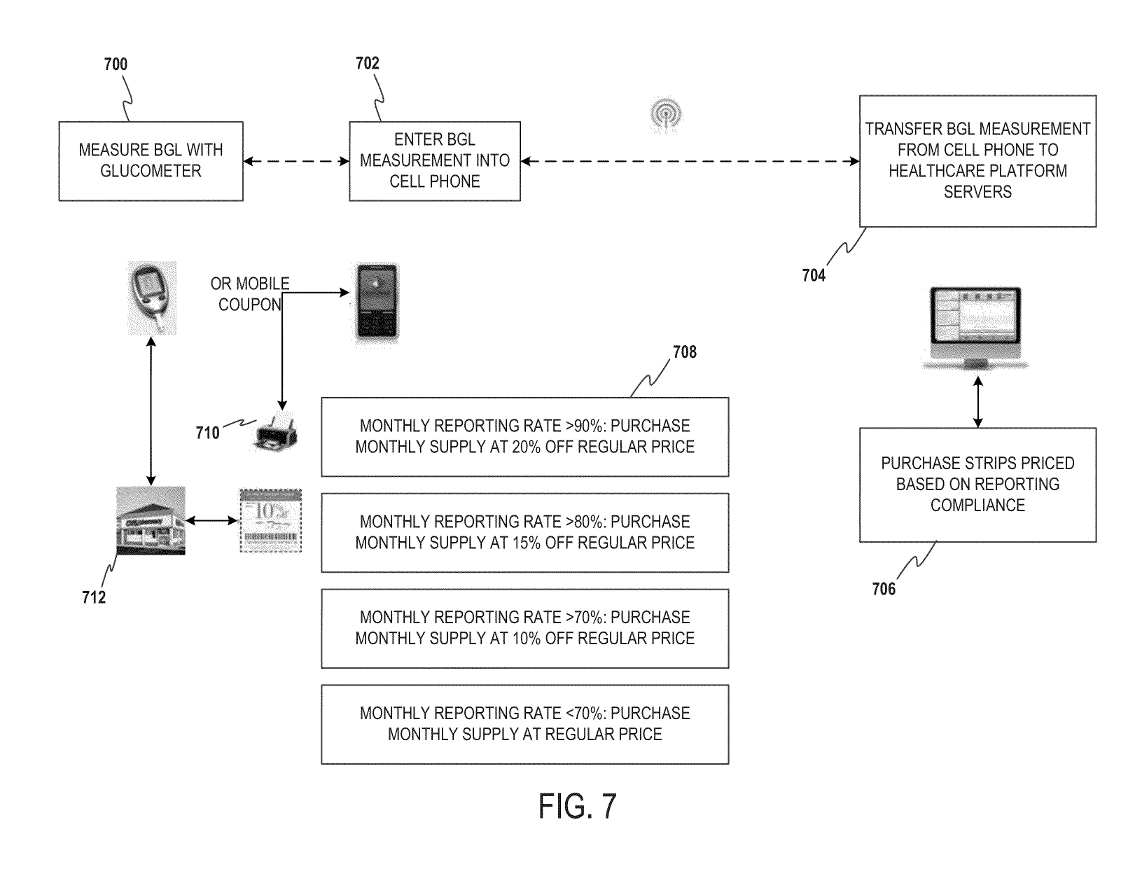

FIG. 7 depicts an illustrative process for a patient participating in the incentive program. The patient may receive a text message asking him/her to measure and report his/her glucose 4 times per day (e.g., at 8 am, 12 pm, 6 pm and 10 pm). The patient may measure 700 his/her glucose with glucometer. The patient may enter 702 his/her blood glucose level (BGL) into his/her cell phone or other mobile device and transfer 704 this information to a healthcare platform system. The healthcare platform system may receive the information and, once the patient has met his/her compliance goal, reward the patient accordingly. For example, the healthcare platform may lower the price 706 on testing strips the patient regularly purchases. The healthcare platform system may send a message 708 to the patient, where the message is dependent on the patient's level of compliance. For example, the message 708 may inform the patient their compliance level was at 93%, and they have received a coupon for 20% off their monthly supply of testing strips. The patient may receive 710 the coupon via email, which can be printed out for redemption, or as a mobile coupon for display on the patient's mobile device. The patient may take 712 the coupon to a pharmacy where they receive their discount.

It should be noted the details discussed above in regard to the discount/coupon incentive program are by way of example only to show one illustrative incentive program. The details may be changed and/or modified depending on the capabilities and functionality of an individual healthcare platform system.

The incentive programs as discussed herein are merely shown by way of example only. Any various incentive programs may be used that encourage a patient to self-report their completed tasks in a medical treatment plan, thereby resulting in a higher level of patients completing their medical treatment plans. Each of the incentive programs as described herein may be modified to include additional features. For example, each program may be modified to provide for accumulation of incentives that are only redeemable upon a certain accomplishment such as a subsequent doctor's visit, a lab visit, or completion of the medical treatment plan entirely.

### Example 3

### Co-Pay/Rewards Card Re-Filled Based on Compliance

Another incentive system may leverage the existence of re-fillable co-pay cards or other forms of debit card like payment mechanisms to reward patients based on their self-reported compliance. Currently, the pharmaceutical industry uses co-pay cards as a way to encourage patients to fill and refill their medication script. A provider or staff usually distributes the co-pay card during a patient's visit at the provider office. At that time, the patient is given a prescription for medication A, a sample of medication A, and a co-pay card for medication A. At the pharmacy, when filling the prescription for medication A, the patient will hand the pharmacist the co-pay card for medication A, and usually a part or the whole co-pay payment amount will be waved for the patient and will be paid for by the pharmaceutical company manufacturing medication A.

The refillable card may be provisioned to have funds in the form of actual monetary currency or a points based system (e.g., reward points) that may be used toward the purchase of medications, medical supplies, or other products and/or services. For example, the card may be provisioned to be used toward co-payment for medication A, for getting an X % discount on supplies (e.g. glucose meter test strips), phone minutes, purchases within a store chain, or it can be open to any monetary purchase. The above described debit cards already exist and can be readily integrated with the healthcare platform system-based incentive program as described herein.

A program sponsor (e.g., pharmaceutical brand) may set up various program parameters such as a program name (e.g., Hypertension), a target self-reported compliance for patient (e.g., minimum 80%), a prize for meeting target (e.g., $20 credit to co-pay card), a time period for goal (e.g., monthly) and a save program.

Once the parameters are set, the healthcare platform system may monitor, on a regular interval (e.g., weekly), patients' self-reported compliance and send patients status update (e.g., “John, your compliance this week is 85%. Good job. You are on your way to receive your $20 co-pay credit”). At the end of the month (or other time period) for which compliance was monitored, the system may evaluate if the patient has met his/her goal, and, assuming he/she has met their goal, will notify the patient (e.g., “John, your compliance for the past month was 82%. Your co-pay card has been recharged with $20”). At or about the same time, the healthcare platform system, through an application programming interface (API), may notify the co-pay card processor that the account holder has reached his/her goal, and to refill their co-pay card. The processor may then refill the card with $20 (or another agreed upon amount) and patient may now be able to present the card at the pharmacy when refilling the script and getting the $20 co-pay waived (i.e., it is paid by the sponsor through the card).

It should be noted the details discussed above in regard to the co-pay/rewards card incentive program are by way of example only to show one illustrative incentive program. The details may be changed and/or modified depending on the capabilities and functionality of an individual healthcare platform system.

### Example 4

### Product Discounts/Coupons Based on Compliance

Another incentive system may reward a patient for meeting pre-specified compliance goals set by a program sponsor by providing them with discounts to their products and/or services. An illustrative use case may be where a Type 1 Diabetes patient is receiving discount coupons from a glucometer manufacturer based on their compliance to a glucose-reporting schedule.

Initially, a PM and/or sponsor may set up compliance goals for the program participants. The PM may set up different levels of compliance and reward patients based on the level of compliance they achieve. To set up the program, the PM may interact with a software application specifically designed for the program. For example, the PM may choose “Glucose” from a tracked value drop-down menu. The PM may then choose the target goal for the program. For example, the target goal is for all patients participating in the program may be to report their glucose values 4 times per day. Depending on the percent of that goal being achieved, the PM may reward the patient with a discount coupon. For example, patients who have achieved 90% or higher may be rewarded with a 20% off coupon, patients achieving between 80% to 89% may receive a 15% off coupon, and so on. The PM may also enter the a restriction, such as glucose values can only be reported and accepted if reported at least 2 or more hours apart in order to prevent patients from “gaming” or scamming the system and reporting 4 values in a row at the end of the day, for example. The PM may also set up maximum number of participants in order to protect the sponsor from overrunning their program budget. Depending on the program constraints, the PM may set up other program parameters such as start date, end date and so forth, and initiates the program.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method for providing an incentive to a patient for self-reported compliance, the method comprising the steps of:
receiving, by a processor, one or more inputs from a patient, wherein the one or more inputs correspond to a self-reporting regimen;
recording, by the processor, the one or more inputs to a database;
analyzing, by the processor, the database to determine whether the one or more inputs meet or exceed a threshold; and
if the threshold is met or exceeded, providing, by the processor, one or more incentives to the patient.

2. The method of claim 1, further comprising the step of:
calculating, by the processor, the threshold by dividing a first number of inputs provided by the patient by a second number of expected inputs to be provided by the patient.

3. The method of claim 2, wherein the threshold is 80%.

4. The method of claim 1, further comprising the step of verifying, by the processor, that the one or more inputs provided by the patient are accurate.

5. The method of claim 1, wherein the one or more incentives are selected from a coupon for a free item, a coupon for a free service, a coupon for a discount on an item, a coupon for a discount on a service, a free prescription refill, a discounted prescription refill, a waived co-pay, points that can be accrued and redeemed for products, points that can be accrued and redeemed for services, a cash back amount, a credit amount, and access to features on an electronic device.

6. The method of claim 5, wherein the electronic device is provided to the patient and comprises one or more programming instructions that are configured to restrict access to one or more features of the electronic device upon receiving a command.

7. The method of claim 5, wherein the electronic device is provided to the patient and comprises one or more programming instructions that are configured to grant access to one or more features of the electronic device upon receiving a command.

8. The method of claim 1, wherein the self-reported compliance comprises compliance with one or more schedules for administering a medication.

9. The method of claim 1, wherein the self-reported compliance comprises compliance with one or more schedules for refilling a prescription.

10. The method of claim 1, wherein the self-reported compliance comprises compliance with one or more schedules for medical treatment.

11. A system for providing an incentive to a patient for self-reported compliance, the system comprising:
a processor; and
a non-transitory, processor-readable storage medium in communication with the processor, wherein the non-transitory, processor-readable storage medium contains one or more programming instructions that, when executed, cause the processor to:
receive one or more inputs from a patient, wherein the one or more inputs correspond to a self-reporting regimen;
record the one or more inputs to a database;
analyze the database to determine whether the one or more inputs meet or exceed a threshold; and
if the threshold is met or exceeded, provide one or more incentives to the patient.

12. The system of claim 11, further comprising one or more programming instructions that, when executed, cause the processor to:
calculate the threshold by dividing a first number of inputs provided by the patient by a second number of expected inputs to be provided by the patient.

13. The system of claim 12, wherein the threshold is 80%.

14. The system of claim 11, further comprising one or more programming instructions that, when executed, cause the processor to verify that the one or more inputs provided by the patient are accurate.

15. The system of claim 11, wherein the one or more incentives are selected from a group of a coupon for a free item, a coupon for a free service, a coupon for a discount on an item, a coupon for a discount on a service, a free prescription refill, a discounted prescription refill, a waived co-pay, points that can be accrued and redeemed for products, points that can be accrued and redeemed for services, a cash back amount, a credit amount and access to features on an electronic device.

16. The system of claim 15, wherein the electronic device is provided to the patient and comprises one or more programming instructions that are configured to restrict access to the features on the electronic device upon receiving a command.

17. The system of claim 15, wherein the electronic device is provided to the patient and comprises one or more programming instructions that are configured to grant access to the features on the electronic device upon receiving a command.

18. The system of claim 11, wherein the self-reported compliance comprises a compliance with one or more schedules for administering a medication.

19. The system of claim 11, wherein the self-reported compliance comprises a compliance with one or more schedules for refilling a prescription.

20. The system of claim 11, wherein the self-reported compliance comprises compliance with one or more schedules for medical treatment.
